(19) United States
(12) Patent Application Publication
(10) Pub. No.: US 2006/0026422 A1
(43) Pub. Date: Feb. 2, 2006

(54) Method, apparatus, and product for providing a backup hardware trusted platform module in a hypervisor environment

(75) Inventors: Steven A. Bade, Georgetown, TX (US); Thomas J. Dewkett, Staatsburg, NY (US); Nia Letise Kelley, Austin, TX (US); Siegfried Sutter, Boeblingen (DE); Helmut H. Weber, Dettenhausen (DE)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/902,711

(22) Filed: Jul. 29, 2004

(51) Int. Cl. H04L 9/00

(52) U.S. Cl. 713/164

(57) ABSTRACT

A method, apparatus, and computer program product are described for implementing a trusted computing environment within a data processing system. The data processing system includes a primary hardware trusted platform module (TPM) and a secondary hardware backup TPM. The data processing system also includes multiple logical partitions. The primary hardware TPM is used to provide trusted computing services to the logical partitions. A determination is made as to whether the primary hardware TPM is malfunctioning. If a determination is made that the primary hardware TPM is malfunctioning, the secondary hardware TPM is designated as a new primary hardware TPM and is utilized instead of the primary TPM to provide trusted computing services to the logical partitions.

### CROSS-REFERENCE TO RELATED APPLICATIONS

The subject matter of the present invention is related to the subject matter of co-pending United States patent applications: serial number XXXX, entitled METHOD, APPARATUS, AND PRODUCT FOR PROVIDING A MULTI-TIERED TRUST ARCHITECTURE, attorney docket number AUS920040170US1; serial number XXXX, entitled METHOD, APPARATUS, AND PRODUCT FOR ASSERTING PHYSICAL PRESENCE WITH A TRUSTED PLATFORM MODULE IN A HYPERVISOR ENVIRONMENT, attorney docket number AUS920040171US1; and serial number XXXX, entitled METHOD, APPARATUS, AND PRODUCT FOR PROVIDING A SCALABLE TRUSTED PLATFORM MODULE IN A HYPERVISOR ENVIRONMENT, attorney docket number AUS920040172US1, all filed on the same date herewith, assigned to the same assignee, and incorporated herein in their entirety by reference.

### BACKGROUND OF THE INVENTION

1. Field of the Invention

The present invention relates to an improved data processing system and, in particular, to a method, apparatus, and computer program product for data storage protection using cryptography. Still more particularly, the present invention relates to a method, apparatus, and computer program product in an environment designed to use a single hardware trusted platform module (TPM) to provide trust services where a backup hardware TPM is also provided to use in case of failure of the primary hardware TPM.

2. Description of Related Art

Most data processing systems contain sensitive data and sensitive operations that need to be protected. For example, the integrity of configuration information needs to be protected from illegitimate modification, while other information, such as a password file, needs to be protected from illegitimate disclosure. As another example, a data processing system needs to be able to reliably identify itself to other data processing systems.

An operator of a given data processing system may employ many different types of security mechanisms to protect the data processing system. For example, the operating system on the data processing system may provide various software mechanisms to protect sensitive data, such as various authentication and authorization schemes, while certain hardware devices and software applications may rely upon hardware mechanisms to protect sensitive data, such as hardware security tokens and biometric sensor devices.

The integrity of a data processing system's data and its operations, however, centers around the issue of trust. A data processing system's data and operations can be verified or accepted by another entity if that entity has some manner for establishing trust with the data processing system with respect to particular data items or particular operations.

Hence, the ability to protect a data processing system is limited by the manner in which trust is created or rooted within the data processing system. To address the issues of protecting data processing systems, a consortium of companies has formed the Trusted Computing Group (TCG) to develop and to promulgate open standards and specifications for trusted computing. According to the specifications of the Trusted Computing Group, trust within a given data processing system or trust between a data processing system and another entity is based on the existence of a hardware or software component within the data processing system that has been termed the trusted platform module (TPM).

A trusted platform enables an entity to determine the state of the software environment in that platform and to seal data to a particular software environment in that platform. The entity deduces whether the state of the computing environment in that platform is acceptable before performing a transaction with that platform. To enable this, the trusted platform provides integrity metrics, also known as integrity measurements, to the entity that reflect the integrity of the software state of the trusted platform. The integrity measurements require a root of trust within the computing platform. In order for a system to be a trusted platform, the integrity measurements must be taken from the Core Root of Trust for Measurements and extended through the initial program load (IPL) process up to the point at which the operating system is initialized.

A trusted platform module has been generally described in a platform-independent manner, but platform-specific descriptions have been created for certain classes of systems, such as personal computers (PCs). Existing hardware for trusted computing has focused on implementations for a single hardware trusted platform module for a single system. This situation is sufficient for simple servers and PCs, which tend to be relatively low-performance computers that meet the needs of stand-alone computational environments or client-side processing environments.

High-performance servers, though, support partitionable, multithreaded environments that may need access to a trusted platform module on multiple threads simultaneously. This type of environment allocates, or partitions, physical resources to each of the supported multiple partitions. In addition, each partition can be thought of as a separate logical computer system that can execute its own operating system and applications. The operating system executed by one partition may be different from the operating systems being executed by the other partitions.

One hardware TPM is designed to provide support for a single, non-partitionable computer system. Thus, existing systems utilize a single hardware TPM to provide trust for the entire single system. These systems, however, were not partitionable environments. A problem then arises as to how to provide support for a partitionable environment which includes multiple partitions which each act as separate computer systems.

In systems which use only a single hardware TPM to provide trust for the entire system, a problem can arise when that single hardware TPM fails to perform properly. When the single hardware TPM malfunctions, no trust services can be provided anywhere in the system until that hardware TPM is serviced or replaced.

Therefore, it would be advantageous to have a mechanism in a partitionable environment which provides a backup hardware TPM that can be used in place of the primary hardware TPM when the primary hardware TPM fails to perform properly.

### SUMMARY OF THE INVENTION

A method, apparatus, and computer program product are described for implementing a trusted computing environment within a data processing system. The data processing system includes a primary hardware trusted platform module (TPM) and a secondary hardware backup TPM. The data processing system also includes multiple logical partitions. The primary hardware TPM is used to provide trusted computing services to the logical partitions. The TPM, as modified by the present invention, is designed to be partitionable by utilizing context slots, each associated with a different logical partition. A determination is made as to whether the primary hardware TPM is malfunctioning. If a determination is made that the primary hardware TPM is malfunctioning, the secondary hardware TPM is designated as a new primary hardware TPM and is utilized instead of the original primary TPM to provide trusted computing services to the logical partitions.

A hypervisor is initialized within the data processing system, and the hypervisor supervises a plurality of logical, partitionable, runtime environments within the data processing system. Each time that the hypervisor creates a logical partition within the data processing system, the hypervisor also instantiates a logical TPM for that partition. The primary hardware TPM is used as a basis to create these logical TPMs for each partition. These logical TPMs provide access for each partition to the hardware TPM. Each partition has an associated context that includes the partition's runtime TPM state and persisted state information. Included in the persisted state information is information about which hardware TPM is currently being used as the primary hardware TPM.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical network of data processing systems, each of which may be used to implement the present invention;

FIG. 1B depicts a typical computer architecture that may be used within a data processing system in which the present invention may be implemented;

FIG. 1C depicts a block diagram that shows an example of a prior art distributed data processing system;

FIG. 2 depicts a block diagram that shows a modified trusted platform architecture in accordance with the present invention;

FIG. 3 is a block diagram of a modified trusted platform module (TPM) that includes context swapping hardware in accordance with the present invention;

FIG. 4A depicts a block diagram that shows a logical organization for a hypervisor-based execution environment within a data processing system that includes a primary physical hardware trusted platform module and a secondary physical hardware trusted platform module in accordance with the present invention;

FIG. 4B depicts the environment of FIG. 4A where the heartbeat from the original primary hardware TPM has been lost and the secondary hardware TPM has become the new primary TPM in accordance with the present invention;

FIGS. 5A and 5B together depict a high level flow chart that illustrates monitoring a heartbeat from each hardware TPM and configuring and designating the secondary, or backup, hardware TPM as the primary hardware TPM when the original primary hardware TPM fails to respond to the heartbeat command in accordance with the present invention;

FIG. 6 illustrates a high level flow chart that depicts configuring the secondary, or backup, TPM to be the primary TPM and transferring context information and a necessary context encryption key so that the original backup hardware TPM can function as the new primary hardware TPM in accordance with the present invention; and

FIG. 7 depicts a high level flow chart that illustrates updating the backup contexts in response to a modification to the primary contexts in accordance with the present invention.

### DETAILED DESCRIPTION OF THE INVENTION

The present invention is a method, apparatus, and computer program product for providing a hardware TPM that provides trust to logical partitions that require trust and that are currently supported within a data processing system. A single hardware TPM is used as the basis to create a logical TPM for each partition. In order to provide a failover environment in case of failure of the primary hardware TPM, a secondary backup hardware TPM is also provided. This backup hardware TPM is used only as a means for backup to replace the primary hardware TPM in case the primary TPM fails to function properly. The environment of the present invention is one in which a single hardware TPM is used to provide trust services.

According to the present invention, the health of the primary and secondary hardware TPMs are periodically monitored by transmitting a heartbeat command to each hardware TPM. If the primary hardware TPM is functioning properly, it will respond to the heartbeat command by transmitting a heartbeat in response to the heartbeat command.

According to the preferred embodiment, a context manager is described that manages and tracks the use of the hardware TPM by each logical partition. This context manager is also responsible for transmitting a heartbeat command, receiving heartbeats, and determining whether each hardware TPM responded to the heartbeat command by transmitting a heartbeat.

The hardware TPM includes a finite number of context slots in which the contexts can be stored. Each partition is associated with, or bound to, a particular context slot in the hardware TPM. Binding a partition to a particular context slot preferably takes place when the data processing system, and thus each partition, is booted. This association is maintained until the data processing system is rebooted. Thus, a partition remains bound to the same context slot until the data processing system is rebooted. Some or all of the context slots may be simultaneously associated with more than one partition. For example, if the data processing system is booted with six partitions and the hardware TPM includes only four context slots, at least one of the slots will be associated with more than one partition. The context manager is responsible for dynamically swapping contexts between context slots and other storage that is not located in the hardware TPM.

If the primary hardware TPM did not respond by transmitting a heartbeat, the context manager will configure the backup to be the primary and then designate the backup hardware TPM as the primary TPM. This newly designated primary TPM is then used as the primary hardware TPM that provides trust services to the data processing system and each of its logical partitions. Therefore, the newly designated primary TPM is the single TPM used by the system to provide trust services throughout the system.

During the boot process of the data processing system, a context encryption key is copied from the original primary hardware TPM and stored in the platform's protected storage, such as in non-volatile memory in a host partition. The contexts that are stored in the original primary hardware TPM are then encrypted using the context encryption key and stored in the protected storage outside of the primary hardware TPM.

The primary and secondary hardware TPMs must share a platform binding key as well as a private TPM endorsement key. These two keys are used to bind, or associate, a particular hardware TPM with a particular platform. Thus, the primary hardware TPM includes a particular platform binding key and a particular private TPM endorsement key that are used to bind this particular primary TPM to the particular platform. In order for the backup hardware TPM to be used as a replacement hardware TPM for the original primary TPM, the backup hardware TPM must also include a copy of that particular platform binding key and that particular private TPM endorsement key. Thus, according to the present invention, a copy of the particular platform binding key and a copy of the private TPM endorsement key are both stored in the backup hardware TPM.

When the primary hardware TPM is malfunctioning, the primary hardware TPM will not respond to the heartbeat command. Thus, if the context engine does not receive a heartbeat from the primary hardware TPM, the context engine determines that the primary hardware TPM is malfunctioning, and begins the process of configuring and designating the backup hardware TPM to be the primary TPM.

The context engine first configures the backup hardware TPM to be the new primary hardware TPM by copying the context key from the platform's protected storage and into the backup hardware TPM. The encrypted contexts are then copied from the platform's protected storage and into the backup hardware TPM which then uses its context encryption key to decrypt the received encrypted contexts. These decrypted contexts are then stored in the backup hardware TPM. The backup hardware TPM already had stored within it the same private TPM endorsement key and platform binding key that were used by the original hardware primary TPM. The context manager then designates the backup hardware TPM by adjusting the identification within the state information in each context that identifies the primary hardware TPM. This identification is adjusted to now point to the backup hardware TPM as the primary hardware TPM. Thus, the backup hardware TPM is now the new primary hardware TPM.

According to the prior art, the Trusted Computing Group (TCG) defines a context. According to the TCG standard, a context including two elements: persistent state information associated with the TPM, and the runtime state of the TPM. The TCG standard further defines exactly what information must be stored in the context.

According to the present invention, a separate context is generated for each partition in the system. Each context for a partition includes the information defined by the TCG and is required to be physically located in the TPM when that partition is attempting to use the TPM. A context key is used to bind the contexts to a particular TPM and is also used to encrypt and decrypt the contexts as described below. Each context is associated with a particular context slot using binding information that is stored with the context that identifies the particular associated context slot.

The following is a description of contexts and how they are used. Each partition has an associated context that must be stored in the hardware TPM when the hardware TPM is providing its services to that partition. Each partition is associated with, or bound to, a particular context slot in the hardware TPM. Binding a partition to a particular context slot preferably takes place when the data processing system, and thus each partition, is booted. This association is maintained until the data processing system is rebooted. Thus, a partition remains bound to the same context slot until the data processing system is rebooted. Some or all of the context slots may be simultaneously associated with more than one partition. For example, if the data processing system is booted with six partitions and the hardware TPM includes only four context slots, at least one of the slots will be associated with more than one partition.

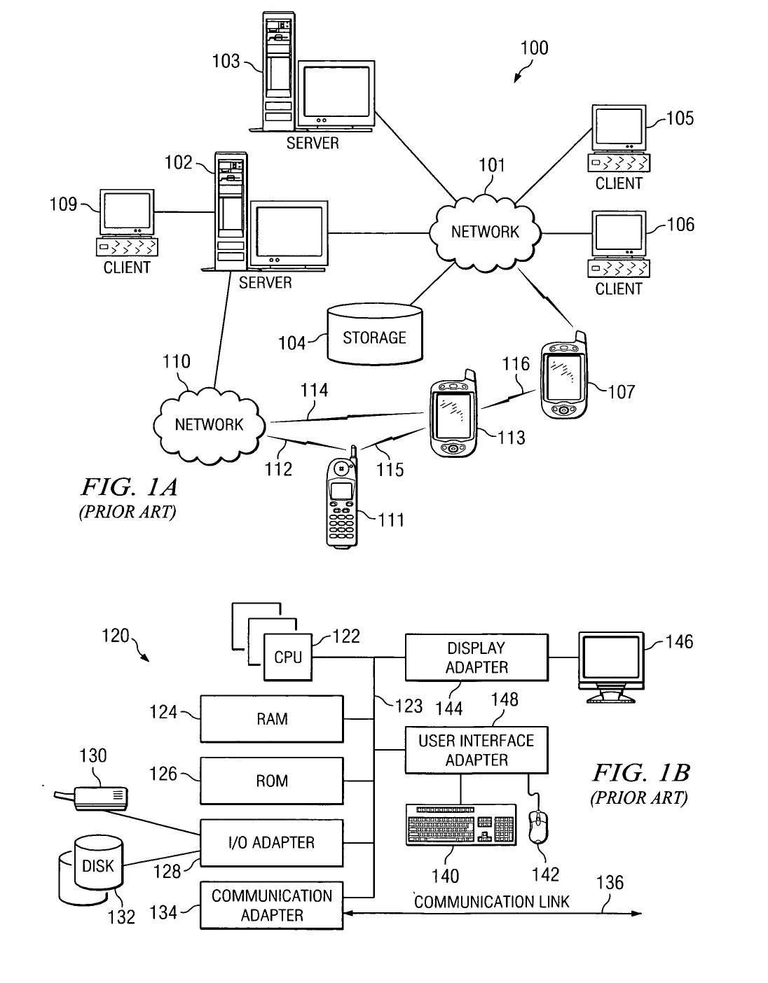

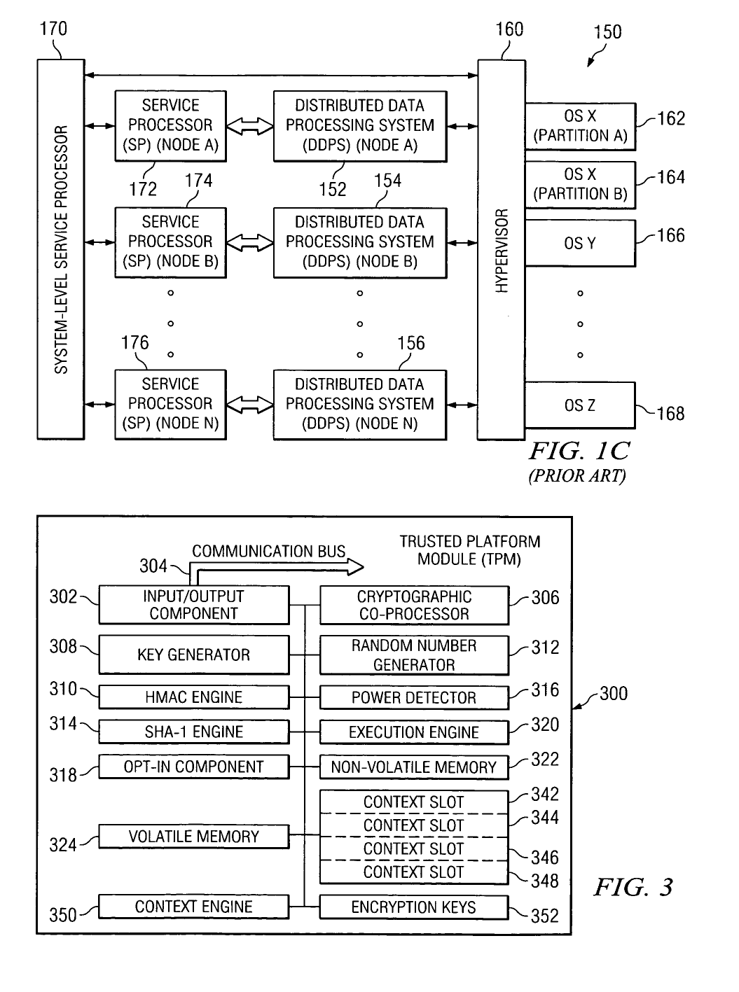

With reference now to the figures, FIG. 1A depicts a typical network of data processing systems, each of which may be used to implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

FIG. 1B depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as an audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

FIG. 1C depicts an example of a prior art distributed data processing system. Distributed data processing system 150 contains multiple nodes 152-156, each of which may represent a single-processor or multi-processor device or card connected to a communication switch or a network; nodes 152-156 may be implemented as central electronic complex (CEC) units. Hypervisor 160 supports multiple instances of one or more operating systems and/or operating system partitions 162-168 on the shared computational resources of the distributed data processing nodes of system 150. Hypervisor 160 communicates with system-level service processor 170, which is responsible for booting system 150 and for monitoring the availability of the shared resources. Each distributed data processing node is associated with a service processor, e.g., service processors 172-176, each of which is responsible for booting its associated node and for assisting system-level service processor 170 in monitoring each of the nodes; a service processor may be associated with a node through a variety of physical connections to its associated node, e.g., the service processor's hardware card may attach to a PCI bus. It should be noted that each node may have a plurality of service processors, although only one service processor would be responsible for booting its associated node.

The present invention could be implemented on a variety of hardware platforms and computational environments; FIG. 1A, FIG. 1B, and FIG. 1C are intended as examples of a heterogeneous computing environment and not as architectural limitations for the present invention.

In addition to being able to be implemented on a variety of hardware platforms and computational environments, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

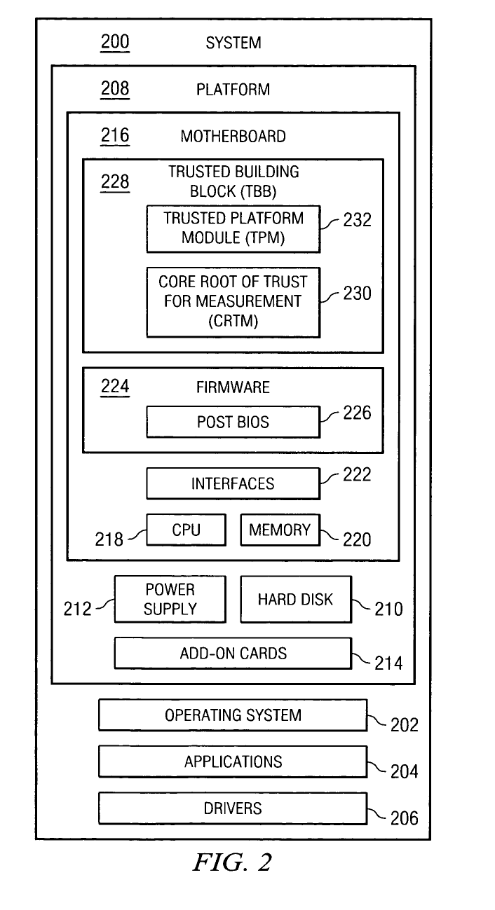

The present invention may be implemented on a variety of hardware and software platforms, as described above. More specifically, though, the present invention is directed to trusted computing platforms. Before describing the present invention in more detail, though, some background information about trusted computing platforms is provided with reference to FIG. 2 for evaluating the operational efficiencies and other advantages of the present invention. Although the present invention may be implemented in conjunction with a variety of trusted computing platforms, possibly in accordance with one or more standards, the examples of the present invention hereinbelow employ the terminology and examples from the standards and/or specifications that have been promulgated by the Trusted Computing Group (TCG); it should be noted, though, that the examples are not meant to imply architectural, functional, nor definitional limitations with respect to embodiments of the present invention.

FIG. 2 depicts a modified trusted platform module according to the present invention. Except as noted below with regard to the present invention, the remaining components of the TPM operate in accordance with the TCG's PC-specific implementation specification.

System 200 supports execution of software components, such as operating system 202, applications 204, and drivers 206, on its platform 208. The software components may be received through a network, such as network 101 that is shown in FIG. 1A, or they may be stored, e.g., on hard disk 210. Platform 208 receives electrical power from power supply 212 for executing the software components on add-on cards 214 and motherboard 216, which includes typical components for executing software, such as CPU 218 and memory 220, although motherboard 216 may include multiple CPUs. Interfaces 222 connect motherboard 216 to other hardware components within system 200, and firmware 224 contains POST BIOS (power-on self-test basic input/output system) 226.

Motherboard 216 also comprises trusted building block (TBB) 228; motherboard 216 is supplied by a manufacturer with TBB 228 and other components physically or logically attached and supplied by the manufacturer. TBB 228 comprises the combination of the core root of trust for measurement (CRTM) component 230, the trusted platform module (TPM) 232, the connection of the CRTM to motherboard 216, and the connection of the TPM to motherboard 216.

TPM 232 is explained in more detail with respect to FIG. 3 hereinbelow. CRTM 230 is an immutable portion of the platform's initialization code that executes upon a platform reset; the platform's execution must begin at the CRTM upon any platform reset event. In this manner, the trust in the platform is based on the CRTM and the behavior of the TPM, and the trust in all measurements is based on the integrity of the CRTM. In the example that is shown in FIG. 2, the BIOS may be assumed to include a BIOS Boot Block and POST BIOS 226; each of these are independent components that can be updated independent of each other, wherein the manufacturer must control the update, modification, and maintenance of the BIOS Boot Block, but a third party supplier may update, modify, or maintain the POST BIOS component. In the example that is shown in FIG. 2, the CRTM may be assumed to be the BIOS Boot Block, and the POST BIOS is a measured component of the chain of trust. Alternatively, the CRTM may comprise the entire BIOS.

FIG. 3 depicts a block diagram that illustrates a modified trusted platform module (TPM) that includes context swapping hardware in accordance with the present invention.

Trusted platform module 300 comprises input/output component 302, which manages information flow over communications bus 304 by performing appropriate protocol encoding/decoding operations and routing of messages to appropriate components. Cryptographic co-processor 306 performs cryptographic operations within a trusted platform module. Key generator 308 creates symmetric keys and RSA asymmetric cryptographic key pairs. HMAC engine 310 performs HMAC (Keyed-Hashing for Message Authentication) calculations, whereby message authentication codes are computed using secret keys as integrity checks to validate information transmitted between two parties, e.g., in accordance with Krawczyk et al., “HMAC: Keyed-Hashing for Message Authentication”, Request for Comments (RFC) 2104, Internet Engineering Task Force (IETF), February 1997.

Random number generator 312 acts as a source of randomness for the computation of various values, such as nonces, keys, or other values. SHA-1 engine 314 implements the SHA-1 hash algorithm. Power detector 316 manages the power states of a trusted platform module in association with the power states of the platform. Opt-in component 318 maintains the state of persistent and volatile flags and enforces semantics associated with those flags such that the trusted platform module may be enabled and disabled. Execution engine 320 runs program code to execute commands that the trust platform module receives through input/output component 302. Non-volatile memory 322 stores persistent identity and state associated with the trusted platform module; the non-volatile memory may store static data items but is also available for storing dynamic data items by entities that are authorized by the trusted platform module owner, whereas volatile memory 324 stores dynamic data items.

TPM 300 also includes multiple context slots, 342, 344, 346, and 348. One context may be stored in each context slot. A context includes the TPM state data and runtime TPM state that are associated with one partition. A context engine 350 may be implemented in hardware as part of TPM 300, or may be implemented in hardware or software elsewhere in the data processing system that includes TPM 300.

Encryption keys 352 are stored within TPM 300. Various encryption keys may be utilized by TPM 300 in order to authenticate another device and/or to communicate with another device. Although encryption keys 352 are depicted separately from the other components of the TPM, the various encryption keys will typically be stored in non-volatile memory 322. The encryption keys may include a private TPM endorsement key, context encryption key used to encrypt a context when that context is stored outside of the TPM, and a platform binding key. Other encryption keys may also be stored in keys 352.

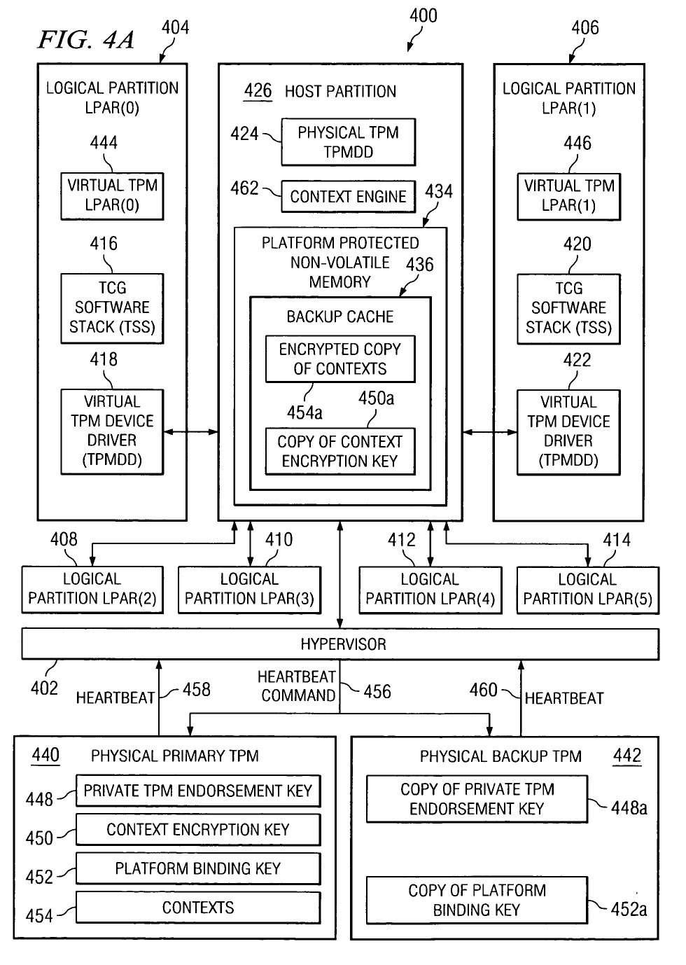

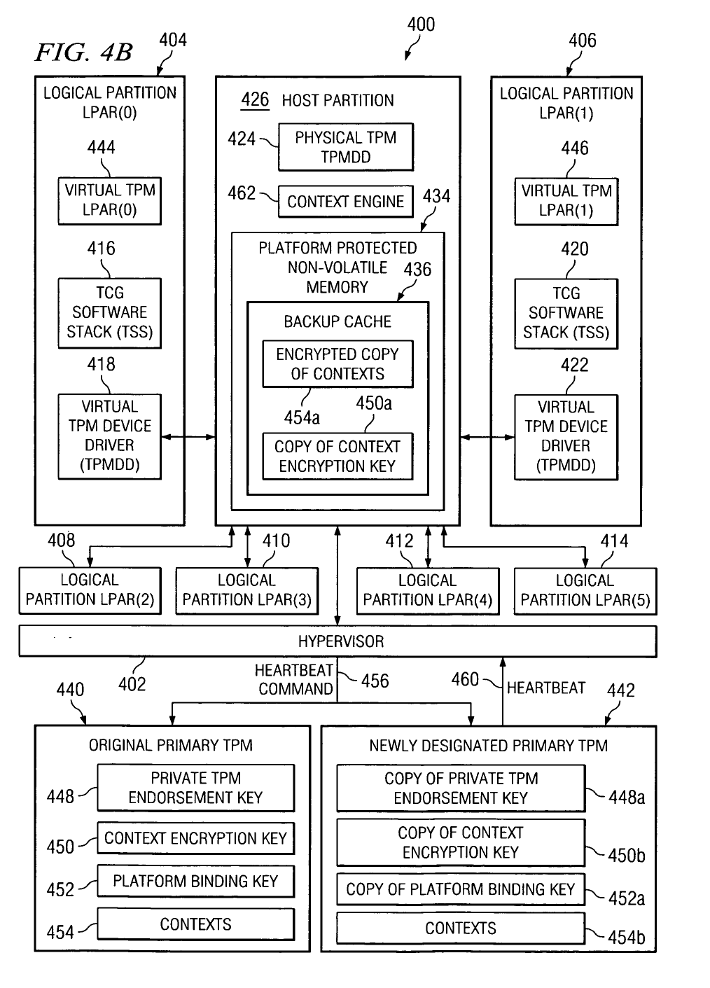

FIG. 4A depicts a block diagram that shows a logical organization for a hypervisor-based execution environment within a data processing system that includes a primary physical hardware trusted platform module and a secondary physical hardware trusted platform module in accordance with the present invention. Data processing system 400 contains a hypervisor 402 that supports multiple instances of one or more operating systems and/or logical partitions (LPAR) on the shared computational resources of data processing system 400. For example, hypervisor 402 supports LPARs 404, 406, 408, 410, 412, and 414.

Each LPAR includes a TCG software stack (TSS) and a TPM device driver (TPMDD). The host partition also includes a TPM device driver. For example, LPAR 404 includes TSS 416 and TPMDD 418, while LPAR 406 includes TSS 420 and TPMDD 422. Host partition 426 includes a physical TPM device driver (TPMDD) 424 for the physical TPM. The other LPARs also include a TSS and TPMDD that are not depicted. TSS 416 and TSS 420 implement the specification of the host programming interfaces that an operating system, an application, or other software component utilizes to interface with a TPM. TSS comprises: the TSS service provider, to which an entity may interface via common application programming interfaces (APIs); the TSS core services, which provides centralized management of key storage, contexts, and handles the direct interaction with the TPM on the host; and the TPM device driver library and the TPMDD, such as TPMDD 418 or TPMDD 422. Generally, all interfacing to the TPM occurs through TSS service provider interface (TSPI) or an API above the TSPI.

Hypervisor 402 is firmware that is responsible for creating and enforcing the partitioning of platform 208 among the various partitions. Hypervisor 402 provides a set of firmware services to the operating system in each partition so that interference between operating system images is prevented. Each partition includes an operating system executing in that partition that may be the same as or different from the operating system that is executing in the other logical partitions. Hypervisor 402 manages the logical partitions, and allocates and manages the physical devices that are allocated to each partition.

When the hypervisor creates a logical partition, the hypervisor instantiates a logical TPM for that partition. For example, the hypervisor instantiated logical, also called virtual, TPM 444 for LPAR(0). The hypervisor instantiated logical TPM 446 for LPAR(1). When the hypervisor terminates a logical partition, the hypervisor destroys the partition's associated logical TPM (LTPM).

A context is associated with each logical partition. The context includes the partition's persisted TPM state information and runtime TPM state. A partition's context is needed by the hardware TPM in order for the hardware TPM to provide its services to that partition. In order for the hardware TPM to provide its services to a particular partition, that partition's context must be stored within the hardware TPM itself.

A context engine is provided that keeps track of which hardware context slot in the hardware TPM is assigned to which partition. The context engine, along with the appropriate context, is used by the hosting partition to route data and commands from a particular logical partition to the hardware TPM.

According to the present invention, two separate physical hardware TPMs are provided in system 400, although only one TPM is at a time used to provide trust services to the system. One hardware TPM, such a TPM 440, acts as a primary TPM, while the other hardware TPM, such as TPM 442, acts as a backup, or secondary, TPM. The primary hardware TPM 440 includes a private TPM endorsement key 448, a context encryption key 450, a platform binding key 452, and contexts 454 for each partition.

A platform binding key and private TPM endorsement key are used to bind a particular hardware TPM to a particular platform. The primary hardware TPM includes a particular private TPM endorsement key and a particular platform binding key. The backup hardware TPM must use the same platform binding key and private TPM endorsement key that are used by the primary hardware TPM because the backup TPM must be able to act as the primary TPM to the same platform in case the primary TPM fails. Thus, the backup hardware TPM 442 includes a copy 448a of the private TPM endorsement key 448, and a copy 452a of the platform binding key 452.

The present invention describes a context encryption key. This key is used to encrypt the contexts when the contexts are to be stored in memory that is not within the hardware TPM itself. For example, according to the present invention, a copy 454a of the contexts 454 may be stored in a backup cache 436 in protected storage 434 in host partition 426. Any time the contexts are stored somewhere other than within a hardware TPM, the contexts must be protected. Therefore, the contexts are encrypted using the context encryption key prior to copying the contexts out of the TPM and into other memory.

In order to configure and designate a backup hardware TPM as a primary hardware TPM and to provide the backup TPM will all of the information and data that it needs to act as a primary TPM, an encrypted copy 454a of contexts 454 and a copy 450a of context encryption key 450 are kept in a backup cache 436 within platform non-volatile protected memory 434.

According to the present invention, a heartbeat command is periodically sent to each hardware TPM 440, 442. If a hardware TPM is performing normally, the hardware TPM will respond to the receipt of a heartbeat command by transmitting back a heartbeat. According to the preferred embodiment, context engine 462 through hypervisor 402 transmits the heartbeat command and receives the heartbeat from each TPM. For example, hardware TPMs 440, 442 will each receive heartbeat command 456. In response, TPM 440 transmits heartbeat 458, and TPM 442 will transmit heartbeat 460 when the TPMs are healthy and performing as designed.

According to the preferred embodiment, a context engine 462 performs the processes of the present invention although those skilled in the art will recognize that any other hardware or software element that is suitably programmed could be used instead. Context engine 462 may be implemented in either hardware or software in system 400 so long as context engine 462 is capable of communicating with hypervisor 402. Context engine 462 is preferably separate from each TPM 440, 442, as depicted in FIGS. 4A and 4B. Context engine 462 may be implemented in host partition 426. However, a context engine, such as context engine 350 depicted in FIG. 3, may be included in a hardware TPM.

The role of the context engine, also called a context manager, is to maintain an association of each virtual TPM to the particular logical partition to which it belongs, and to track and maintain information that indicates with which particular hardware context a particular virtual TPM is associated. Each hardware TPM is capable of being partitioned for use by multiple logical partitions through the use of the context manager and context slots.

If a hardware TPM is malfunctioning or is not functioning at all, the TPM will not respond to a heartbeat command by transmitting a heartbeat. FIG. 4B depicts the environment of FIG. 4A where the heartbeat from the original primary hardware TPM 440 has been lost and the secondary hardware TPM 442 has become the new primary TPM in accordance with the present invention. Because heartbeat 458 was not received by hypervisor 402, context engine 462 will begin the process of configuring and designating TPM 442 as a primary hardware TPM.

Context engine 462 copies the copy 450a of context encryption key 450 to backup TPM 442 and stores it as copy 450b. Context engine 462 then copies the encrypted copy 454a of contexts 454 to TPM 442 and stores it as copy 454b. Backup TPM 442 uses its copy 450b of context encryption key 450 to decrypt contexts 454b. At this time, backup TPM 442 includes within it the information that is necessary to provide TPM services to system 400. TPM 442 is then designated as the primary TPM by context engine 462 by adjusting all context routing information to indicate TPM 442 as the primary TPM.

The contexts remain stored in primary TPM 440 during normal operation while TPM 440 acts as the primary TPM. Data in these contexts may need to be updated from time to time. When information in a context is updated, the copy of the contexts that is stored in backup cache 436 is also updated. In this manner, the copy of the contexts will always accurately reflect the same information that is stored in the contexts in the TPM itself.

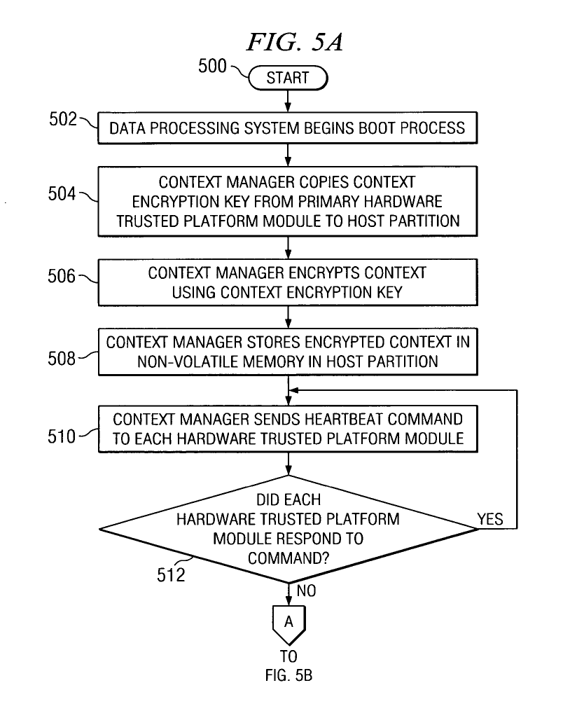

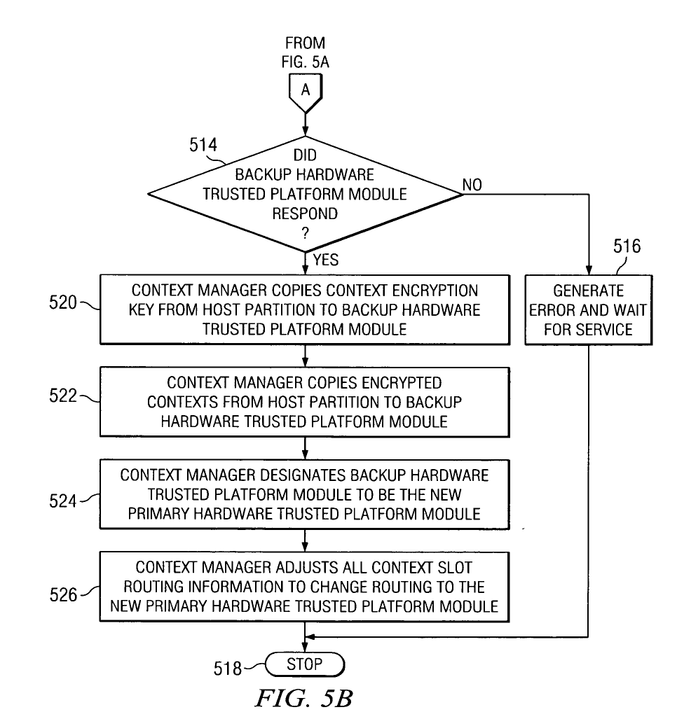

FIGS. 5A and 5B together depict a high level flow chart that illustrates monitoring a heartbeat from each hardware TPM and configuring and designating the backup hardware TPM as a primary hardware TPM when the original primary hardware TPM fails to respond to the heartbeat command in accordance with the present invention. The process starts as depicted by block 500 and thereafter passes to block 502 which illustrates the data processing system beginning a boot process. Next, block 504 depicts the context manager copying the context encryption key from the primary hardware TPM to the host partition. Thereafter, block 506 illustrates the context manager encrypting the context using the context encryption key.

The process then passes to block 508 which depicts the context manager storing the encrypted context in non-volatile memory in the host partition. Block 510, then, illustrates the context manager sending the heartbeat command to each hardware TPM. Thereafter, block 512 depicts a determination of whether or not each hardware TPM responded to the heartbeat command with a heartbeat. If each hardware TPM did respond by transmitting a heartbeat to the hypervisor, the process passes back to block 510. Referring again to block 512, if a determination is made that one of the TPMs did not respond by transmitting a heartbeat, the process passes to block 514 which illustrates a determination of whether or not the backup hardware TPM transmitted a heartbeat. If a determination is made that the backup hardware TPM did not transmit a heartbeat, the process passes to block 516 which illustrates generating an error and waiting for either replacement or service of the backup hardware TPM. The process then terminates as depicted by block 518.

Referring again to block 514, if a determination is made that the backup TPM did respond by transmitting a heartbeat, the process passes to block 520 which depicts the context manager copying the context encryption key from the host partition to the backup hardware TPM. Next, block 522 illustrates the context manager copying the encrypted contexts from the host partition to the backup hardware TPM. The process then passes to block 524 which depicts the context manager designating the backup hardware TPM to be the new primary hardware TPM. Thereafter, block 526 illustrates the context manager adjusting all context routing information to change the routing to the new primary hardware TPM. The process then terminates as illustrated by passing back to block 518.

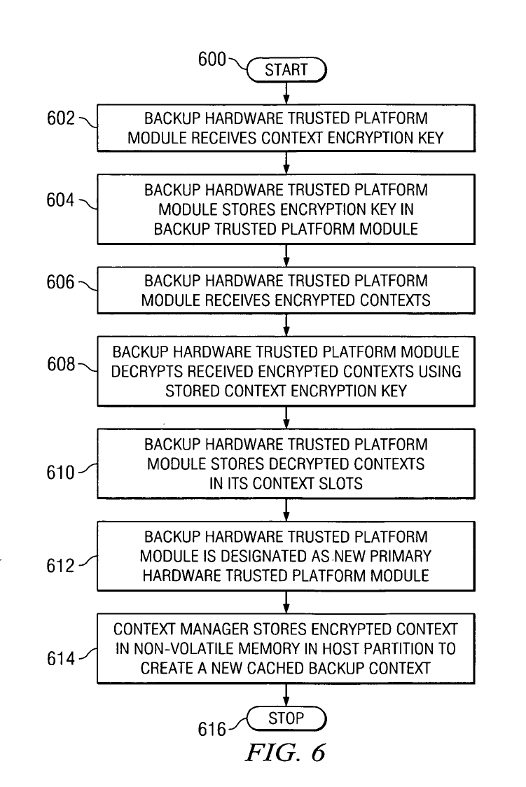

FIG. 6 illustrates a high level flow chart that depicts transferring context information and a necessary context encryption key so that the original backup hardware TPM can function as the new primary hardware TPM in accordance with the present invention. The process starts as depicted by block 600 and thereafter passes to block 602 which illustrates the backup hardware TPM receiving a context encryption key. Next, block 604 depicts the backup hardware TPM storing the encryption key in the backup hardware TPM. Thereafter, block 606 illustrates the backup hardware TPM receiving encrypted contexts.

The process then passes to block 608 which depicts the backup hardware TPM decrypting the received encrypted contexts using the stored context encryption key. Block 610, then, illustrates the backup hardware TPM storing the decrypted contexts in the backup hardware TPM's context slots. Thereafter, block 612 depicts the backup hardware TPM being designated as the new primary hardware TPM. Next, block 614 illustrates the context managing encrypting the contexts and storing them in the host partition to create new cached backup contexts. The process then terminates as illustrated by block 616.

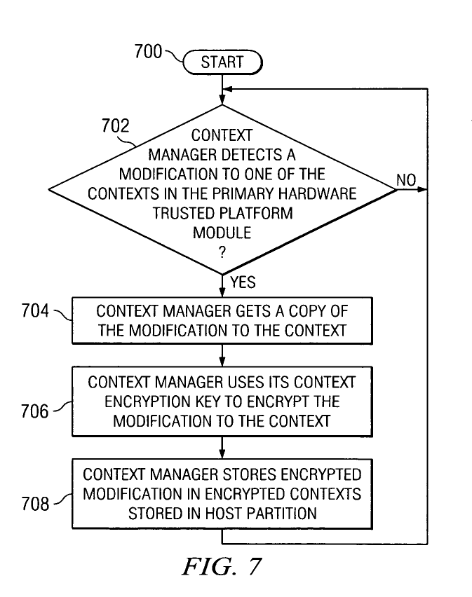

FIG. 7 depicts a high level flow chart that illustrates updating the backup contexts in response to a modification to the primary contexts in accordance with the present invention. The process starts as depicted by block 700 and thereafter passes to block 702 which illustrates a determination of whether or not the context manager detects a modification to one of the contexts in the primary hardware TPM. If a determination is made that the context manager does not detect any modification to one of the contexts in the primary hardware TPM, the process passes back to block 702. If a determination is made that the context manager does detect a modification to one of the contexts in the primary hardware TPM, the process passes to block 704 which depicts the context manager getting a copy of the modification to the context.

Next, block 706 illustrates the context manager using the context encryption key to encrypt the modification to the context. Block 708, then, depicts the context manager storing the encrypted modification in the encrypted contexts that are stored in the host partition. The process then passes back to block 702.

It is important to note that while the present invention has been described in the context of a fully functioning data processing system. Those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for implementing a trusted computing environment within a data processing system, the method comprising:
providing an original primary hardware trusted platform module (TPM) in said system;
providing an original secondary hardware backup TPM in said system;
providing a plurality of logical partitions in said data processing system;
utilizing said original primary hardware TPM to provide trusted computing services to said plurality of logical partitions;
determining whether said original primary hardware TPM is malfunctioning; and
in response to determining that said original primary hardware TPM is malfunctioning, designating said original secondary hardware TPM as a new primary hardware TPM and utilizing said new primary hardware TPM instead of said original primary TPM to provide trusted computing services to said plurality of logical partitions.

2. The method according to claim 1, further comprising:
determining whether said original primary hardware TPM is malfunctioning by:
periodically transmitting a heartbeat command to said original primary hardware TPM and waiting for a period of time for a response from said original primary hardware TPM;
in response to a failure to receive a response during said period of time, determining that said original primary hardware TPM is malfunctioning.

3. The method according to claim 2, further comprising:
in response to determining that said original primary hardware TPM is malfunctioning, configuring said original secondary hardware TPM to act as a primary TPM and designating said original secondary hardware TPM to be said new primary hardware TPM; and
utilizing said new primary hardware TPM instead of said original hardware TPM to provide trust services.

4. The method according to claim 1, further comprising:
generating a context for each one of said logical partitions, each of said contexts including state and runtime TPM information that must be located within a TPM in order for said TPM to provide trust services to a logical partition for which said context had been generated.

5. The method according to claim 1, further comprising:
generating a context encryption key for said original primary hardware TPM;
storing said context encryption key in said original primary TPM;
generating a context for each one of said logical partitions, each of said contexts including state and runtime TPM information that must be located within a TPM in order for said TPM to provide trust services to a logical partition for which said context had been generated;
storing said contexts in said original primary TPM;
encrypting each of said contexts utilizing said context encryption key;
storing said encrypted contexts in backup storage outside of said original primary TPM and said original secondary TPM.

6. The method according to claim 5, further comprising:
in response to determining that said original primary TPM is malfunctioning, copying said encryption key to said original secondary TPM;
copying said encrypted contexts from said backup storage to said original secondary TPM; and
decrypting said copied encrypted contexts within said original secondary TPM.

7. The method according to claim 6, further comprising:
designating said original secondary TPM as said new primary TPM by updating said contexts to point to said original secondary TPM as a primary TPM.

8. An apparatus for implementing a trusted computing environment within a data processing system, said apparatus comprising:
an original primary hardware trusted platform module (TPM) included in said system;
an original secondary hardware backup TPM included in said system;
said data processing system logically partitioned into a plurality of logical partitions;
said original primary hardware TPM providing trusted computing services to said plurality of logical partitions;
a context manager for determining whether said original primary hardware TPM is malfunctioning; and
in response to determining that said original primary hardware TPM is malfunctioning, said original secondary hardware TPM being designated as a new primary hardware TPM and utilizing said new primary hardware TPM instead of said original primary TPM to provide trusted computing services to said plurality of logical partitions.

9. The apparatus according to claim 8, further comprising:
said context manager determining whether said original primary hardware TPM is malfunctioning by:
a hypervisor for periodically transmitting a heartbeat command to said original primary hardware TPM and waiting for a period of time for a response from said original primary hardware TPM;
in response to a failure to receive a response during said period of time, said context manager for determining that said original primary hardware TPM is malfunctioning.

10. The apparatus according to claim 9, further comprising:
in response to determining that said original primary hardware TPM is malfunctioning, said original secondary hardware TPM being configured to act as a primary TPM and designating said original secondary hardware TPM to be said new primary hardware TPM; and
said new primary hardware TPM instead of said original hardware TPM being utilized to provide trust services.

11. The apparatus according to claim 8, further comprising:
a context for each one of said logical partitions, each of said contexts including state and runtime TPM information that must be located within a TPM in order for said TPM to provide trust services to a logical partition for which said context had been generated.

12. The apparatus according to claim 8, further comprising:
a context encryption key for said original primary hardware TPM;
said context encryption key stored in said original primary TPM;
a context generated for each one of said logical partitions, each of said contexts including state and runtime TPM information that must be located within a TPM in order for said TPM to provide trust services to a logical partition for which said context had been generated;
said contexts stored in said original primary TPM;
each of said contexts being encrypted utilizing said context encryption key;
backup storage outside of said original primary TPM and said original secondary TPM for storing said encrypted contexts.

13. The apparatus according to claim 12, further comprising:
in response to determining that said original primary TPM is malfunctioning, said encryption key being copied to said original secondary TPM;
said encrypted contexts being copied from said backup storage to said original secondary TPM; and
said copied encrypted contexts being decrypted within said original secondary TPM.

14. The apparatus according to claim 13, further comprising:
said original secondary TPM being designated as said new primary TPM by updating said contexts to point to said original secondary TPM as a primary TPM.

15. A computer program product for implementing a trusted computing environment within a data processing system, the product comprising:
providing an original primary hardware trusted platform module (TPM) in said system;
providing an original secondary hardware backup TPM in said system;
providing a plurality of logical partitions in said data processing system;
utilizing said original primary hardware TPM to provide trusted computing services to said plurality of logical partitions;
instructions for determining whether said original primary hardware TPM is malfunctioning; and
in response to determining that said original primary hardware TPM is malfunctioning, instructions for designating said original secondary hardware TPM as a new primary hardware TPM and utilizing said new primary hardware TPM instead of said original primary TPM to provide trusted computing services to said plurality of logical partitions.

16. The product according to claim 15, further comprising:
instructions for determining whether said original primary hardware TPM is malfunctioning by:
instructions for periodically transmitting a heartbeat command to said original primary hardware TPM and waiting for a period of time for a response from said original primary hardware TPM;
in response to a failure to receive a response during said period of time, instructions for determining that said original primary hardware TPM is malfunctioning.

17. The product according to claim 16, further comprising:
in response to determining that said original primary hardware TPM is malfunctioning, instructions for configuring said original secondary hardware TPM to act as a primary TPM and designating said original secondary hardware TPM to be said new primary hardware TPM; and
instructions for utilizing said new primary hardware TPM instead of said original hardware TPM to provide trust services.

18. The product according to claim 15, further comprising:
instructions for generating a context for each one of said logical partitions, each of said contexts including state and runtime TPM information that must be located within a TPM in order for said TPM to provide trust services to a logical partition for which said context had been generated.

19. The product according to claim 15, further comprising:
instructions for generating a context encryption key for said original primary hardware TPM;
instructions for storing said context encryption key in said original primary TPM;
instructions for generating a context for each one of said logical partitions, each of said contexts including state and runtime TPM information that must be located within a TPM in order for said TPM to provide trust services to a logical partition for which said context had been generated;
instructions for storing said contexts in said original primary TPM;
instructions for encrypting each of said contexts utilizing said context encryption key;
instructions for storing said encrypted contexts in backup storage outside of said original primary TPM and said original secondary TPM.

20. The product according to claim 19, further comprising:
in response to determining that said original primary TPM is malfunctioning, instructions for copying said encryption key to said original secondary TPM;
instructions for copying said encrypted contexts from said backup storage to said original secondary TPM;
instructions for decrypting said copied encrypted contexts within said original secondary TPM
instructions for designating said original secondary TPM as said new primary TPM by updating said contexts to point to said original secondary TPM as a primary TPM.
